(19) United States
(12) Patent Application Publication
(10) Pub. No.: US 2019/0209983 A1
(43) Pub. Date: Jul. 11, 2019

(54) Mixing Bowl Cover

(71) Applicant: Dina Hartstein, Chicago, IL (US)

(72) Inventor: Dina Hartstein, Chicago, IL (US)

(21) Appl. No.: 16/358,251

(22) Filed: Mar. 19, 2019

Related U.S. Application Data
(63) Continuation-in-part of application No. 29/613,538, filed on Aug. 10, 2017, now Pat. No. D848206.

(51) Int. Cl. B01F 9/00; A47J 43/07

(52) U.S. Cl. CPC B01F 9/0001; A47J 43/0727

(57) ABSTRACT

The mixing bowl is an apparatus that shields a user from getting splashed with ingredients within the mixing bowl. The apparatus includes a main lid, a supplementary lid, a central slot, a refill slot, and a first cover. The main lid shields the ingredients being mixed within the mixing bowl from splashing past the rim of the mixing bowl. The main lid includes a main plate, a frame, and a rim. The ingredients splash against the main plate. The frame guides additional ingredients into the mixing bowl, through the refill slot. The rim secures the main plate against the wall of the mixing bowl. At least one wire beater traverses into the mixing bowl through the central slot. The main lid may remain connected with the mixing bowl while adding additional ingredients as additional ingredients are added through the refill slot.

The current application is a continuation-in-part (CIP) application of the U.S. design application Ser. No. 29/613,538 filed on Aug. 10, 2017.

### FIELD OF THE INVENTION

The present invention relates generally to kitchen tools. More specifically, the present invention is a mixing bowl cover that shields a user from any splashes or spillage from a mixing bowl.

### BACKGROUND OF THE INVENTION

Baking can cause a large mess in the kitchen and make clothing very difficult to clean. Getting sprayed with flour while kneading dough or dividing and shaping mixtures are common, and inevitable ways of creating a mess. Mixing bowls are commonly used baking tools that also easily create messes regardless of the utensil or kitchen appliance used to mix ingredients within the mixing bowl. Allowing ingredients to spill and splash out of the mixing bowl may adjust the proportions of ingredients within the mixture.

The present invention serves to eliminate any messes while using a mixing bowl while allowing a user to continuously bake while using the present invention with a mixing bowl. The present invention may be attached with a variety of mixing bowls and shields a user from any splashes of ingredients while the user mixes ingredients with an electric mixer, a spatula, and a variety of other mixing tools. Additional ingredients may be added throughout the mixing of ingredients with the present invention attached onto the mixing bowl. The present invention facilitates the baking process while ensuring all ingredients added within the mixing bowl remain in the mixing bowl, and more importantly, within the mixture.

### BRIEF DESCRIPTION OF THE DRAWINGS

FIG. 1 is a top perspective view of a preferred embodiment of the present invention.

FIG. 2 is a bottom perspective view of a preferred embodiment of the present invention.

FIG. 3 is a top side view of a preferred embodiment of the present invention.

FIG. 4 is a top perspective view of a preferred embodiment of the present invention with a supplementary lid separated from a main lid.

FIG. 5 is a bottom perspective view of a preferred embodiment of the present invention with a refill slot opened with a first cover.

FIG. 6 is a top perspective view of an alternate embodiment of the present invention engaged with a funnel.

FIG. 7 is a bottom perspective view of an alternate embodiment of the present invention engaged with the funnel.

### DETAILED DESCRIPTION OF THE INVENTION

All illustrations of the drawings are for the purpose of describing selected versions of the present invention and are not intended to limit the scope of the present invention.

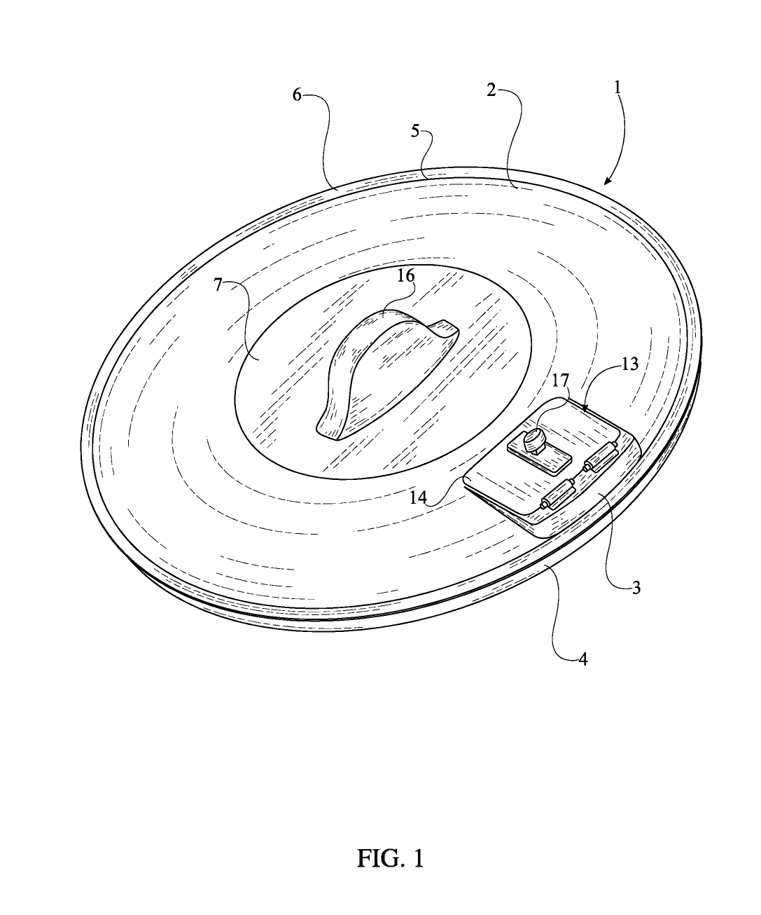

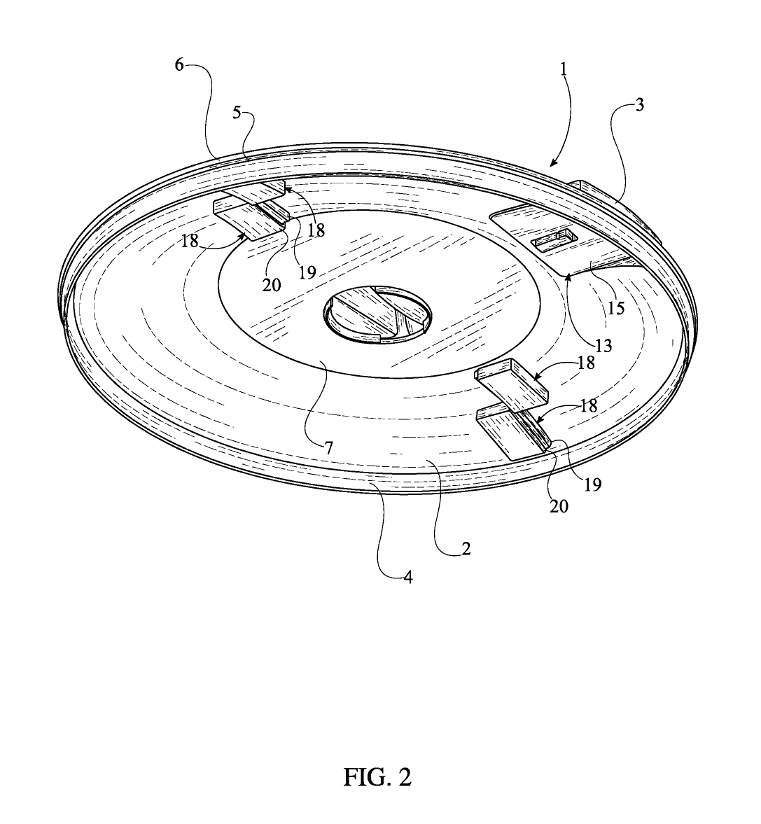

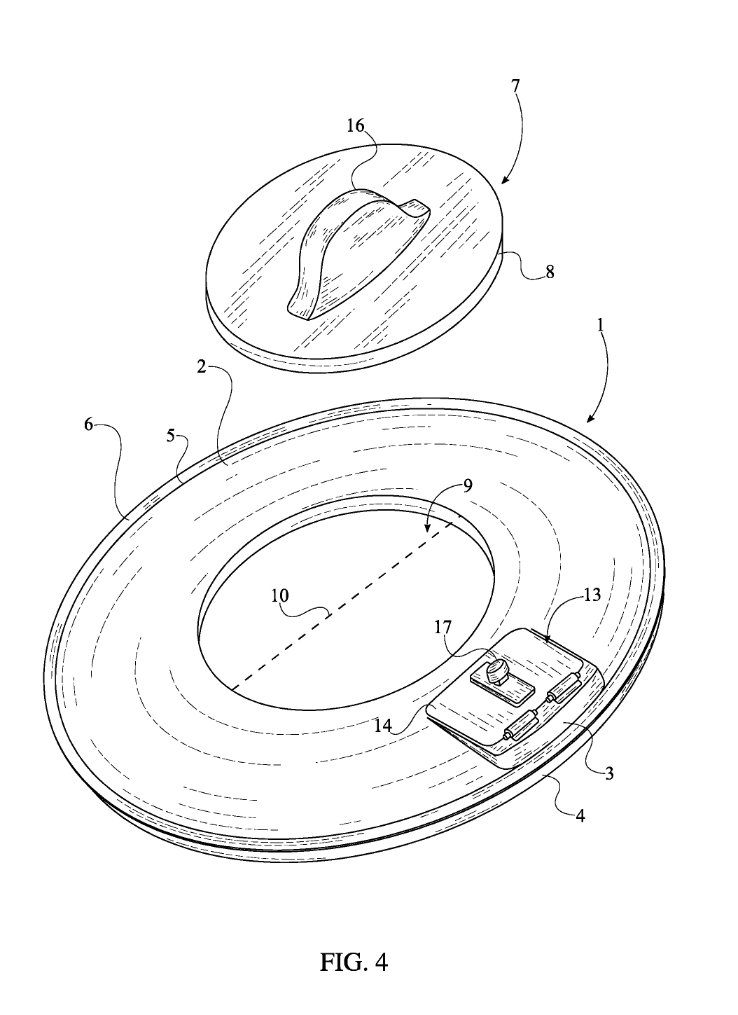

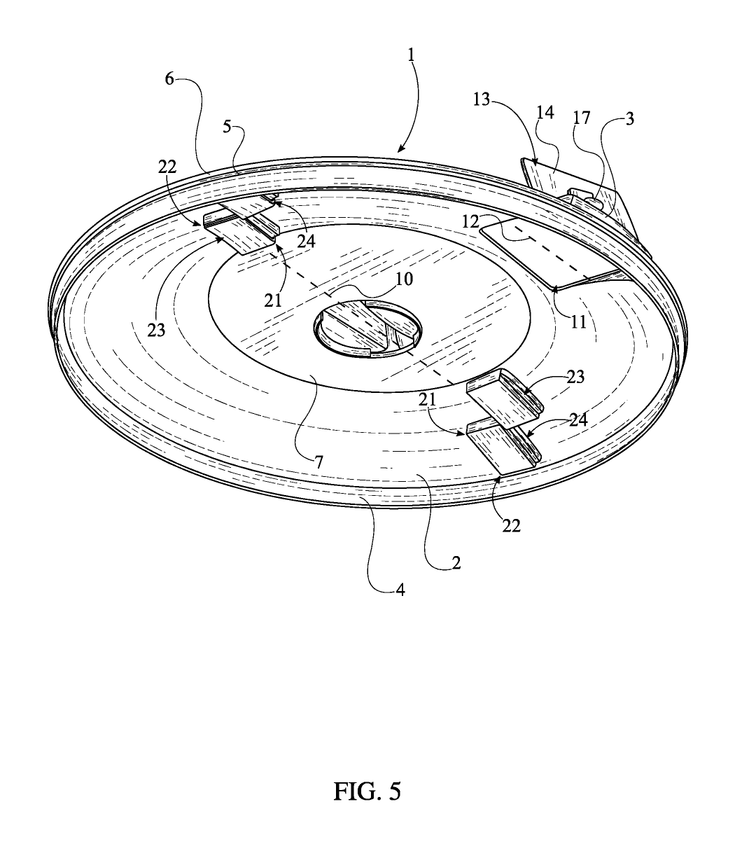

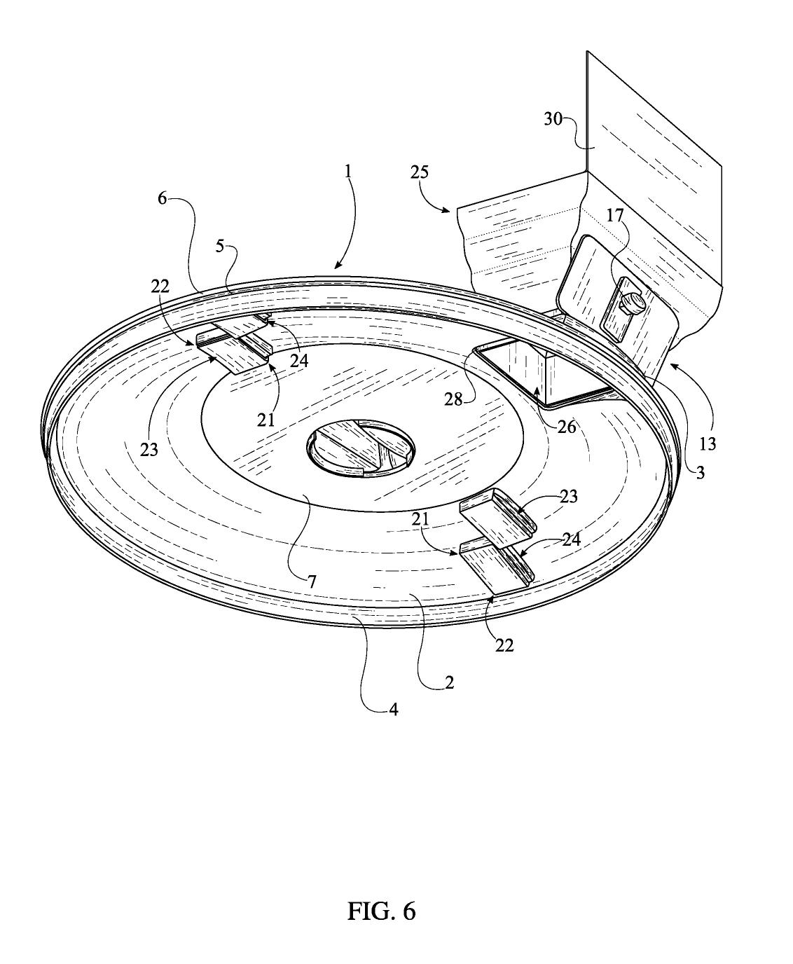

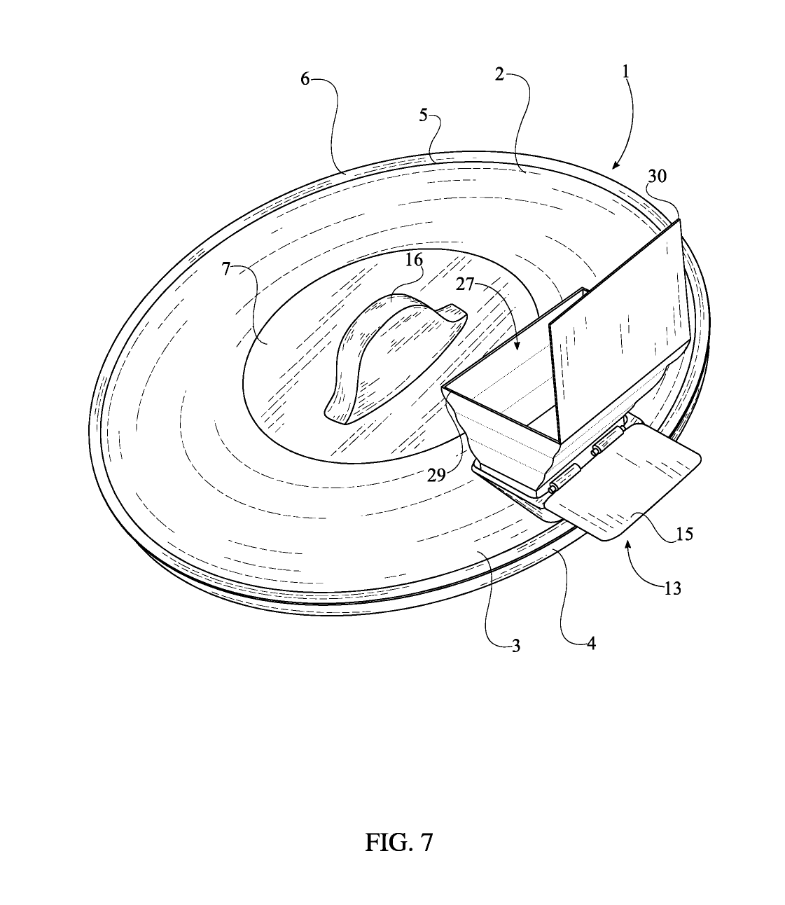

The present invention is a mixing bowl cover that allows a user to mix ingredients within a mixing bowl without getting splashed while the ingredients are getting mixed. Moreover, the present invention fully covers a mixing bowl in order to seal the mixing bowl for storage and transportation. The present invention may cover a variety of corresponding bowls. In order to shield a user from ingredients being mixed within the mixing bowl, the present invention comprises a main lid 1, a supplementary lid 7, a central slot 9, a refill slot 11, and a first cover 13, seen in FIG. 1 and FIG. 6. The main lid 1 shields the user from ingredients being mixed within a mixing bowl and attaches the present invention with the mixing bowl. The main lid 1 comprises a main plate 2, a frame 3, and a rim 4, shown in FIG. 1, FIG. 2, FIG. 4, FIG. 5, FIG. 6, FIG. 7. The main plate 2 serves as an extension of a wall of the mixing bowl over the opening of a mixing bowl. The frame 3 surrounds the refill slot 11 and upholds the first cover 13. The rim 4 allows the main lid 1 to frictionally engage with the wall of the mixing bowl. The supplementary lid 7 seals the central slot 9 which allows at least one wire beater or utensil to mix the ingredients within the mixing bowl. The supplementary lid 7 and the main lid 1 house the ingredients within a mixing bowl. The refill slot 11 allows ingredients to be added to the mixing bowl while a wire beater or a utensil is positioned within the mixing bowl through the central slot 9. Moreover, the main lid 1 may remain connected with the mixing bowl while adding more ingredients through the refill slot 11. The first cover 13 seals the refill slot 11 while not in use.

The overall configuration of the aforementioned components allows the present invention to contain and house ingredients within a mixing bowl while being able to add more ingredients to the mixing bowl while the present invention is attached. The rim 4 is perimetrically fixed with the main plate 2 so that the rim 4 presses against the wall of a mixing bowl, seen in FIG. 5 and FIG. 6. The user may continue to use the mixing bowl as if the present invention is not attached with the mixing bowl as the central slot 9 and the refill slot 11 traverse through the main plate 2. The refill slot 11 is positioned within the frame 3 so that the frame 3 may guide additional ingredients into the mixing bowl. More specifically, the frame 3 is fixed with the main plate 2 and is positioned opposite the rim 4. In order for the main lid 1 to frictionally engage with the wall of the mixing bowl, the main plate 2 is oriented perpendicular with the rim 4. Moreover, the main plate 2 is oriented perpendicular with the frame 3 also allowing the ingredients to simply fall into the mixing bowl.

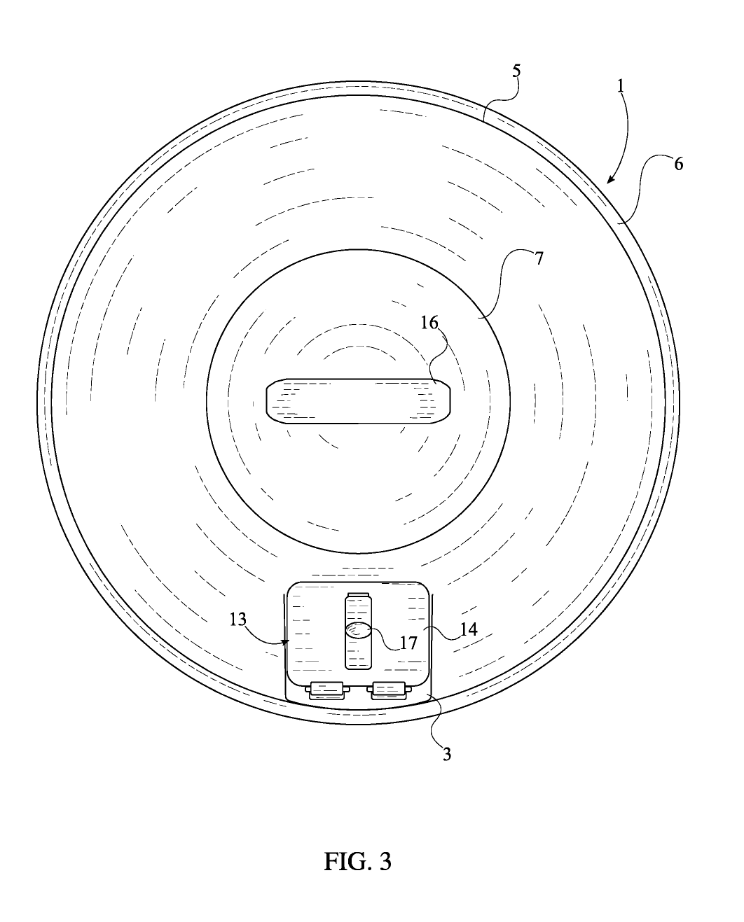

A wire beater is centrally positioned with a mixing bowl as the frame 3 is positioned between the central slot 9 and an outer edge 5 of the main plate 2, seen in FIG. 5. Consequently, the central slot 9 is centrally positioned with the main plate 2, seen in FIG. 3. Moreover, a first width 10 of the central slot 9 is larger than a second width 12 of the refill slot 11. The first width 10 allows at least one wire beater to freely and continuously traverse through the main plate 2. The second width 12 accommodates additional ingredients to be added in the mixing bowl.

As seen in FIG. 4, the ingredients within the mixing bowl may be accessed and housed as the supplementary lid 7 is removably coupled with the central slot 9. The refill slot 11 is sealed as the first cover 13 is positioned adjacent the frame 3 and is hingedly coupled with the frame 3.

In order for the main lid 1 to be positioned along a rim 4 of the mixing bowl, adjacent the opening of the mixing bowl, the main lid 1 comprises a lip 6, shown in FIG. 1, FIG. 2, FIG. 4, FIG. 5, FIG. 6, FIG. 7. The lip 6 stops the main plate 2 and the rim 4 from slipping into the mixing bowl. The lip 6 is perimetrically fixed around the main plate 2 and is oriented parallel with the main plate 2. This arrangement allows lip 6, and consequently the main plate 2, to rest on the rim 4 of the mixing bowl. Furthermore, this arrangement positions the rim 4 against the wall of the mixing bowl.

The present invention further comprises a handle 16. A user easily separates the supplementary lid 7 from the main plate 2 with the handle 16, seen in FIG. 1, FIG. 3, FIG. 4, and FIG. 7. The handle 16 is fixed with the supplementary lid 7 so that the user may maneuver the supplementary lid 7 while the main plate 2 remains stationary with the mixing bowl. The user may grasp the handle 16 while the supplementary lid 7 is positioned within the central slot 9 as the handle 16 is oriented away from the rim 4 of the main lid 1. The supplementary lid 7 is remains positioned within the central slot 9 while pushed within the central slot 9 with the handle 16 as a lateral surface 8 of the supplementary lid 7 is frictionally engaged with the central slot 9.

The present invention further comprises a knob 17 in order to maneuver the first cover 13, seen in FIG. 1, FIG. 3, FIG. 4, and FIG. 6. The knob 17 is fixed onto a surface of the first cover 13. The first surface 14 is positioned opposite a second surface 15 of the first cover 13, and the second surface 15 is positioned adjacent the frame 3. In the preferred embodiment of the present invention, the refill slot 11, the frame 3, and the first cover 13 traverse across an outer edge 5 of the main plate 2 such that larger ingredients may be easily added into through the refill slot 11. The knob 17 is preferably centrally positioned across the first cover 13 so that the first cover 13 easily opens and closes.

In order to accommodate mixing bowls with an opening with a smaller width than that of the width of the rim 4, the present invention further comprises a plurality of hooks 18, shown in FIG. 2, FIG. 5, and FIG. 6. The plurality of hooks 18 allows the main plate 2 to be secured with the wall of a mixing bowl with a smaller opening. Each hook of the plurality of hooks 18 comprises a base 19 and a flexible arm 20. The base 19 connects the corresponding flexible arm 20 with the main plate 2. The plurality of hooks 18 attaches onto the rim 4 of a mixing bowl with a smaller opening as the base 19 is fixed to the main plate 2 and is positioned within the rim 4. The main plate 2 is structurally reinforced along the connection between main plate 2 and the wall of the mixing bowl as the flexible arm 20 is positioned adjacent the base 19, positioned opposite the main plate 2. The plurality of hooks 18 effectively latches onto the rim 4 of the mixing bowl with a smaller opening as the flexible arm 20 traverses across the base 19. More specifically, a fixed end 21 of the flexible arm 20 is terminally fixed with the base 19. The fixed end 21 is positioned opposite a free end 22 of the flexible arm 20 across the flexible arm 20. In order for the wall of the mixing bowl to traverse into the corresponding hook of the plurality of hooks 18, the fixed end 21 is oriented towards the rim 4. The main plate 2 is stabilized with a mixing bowl with a smaller opening as the plurality of hooks 18 is radially distributed across the main plate 2.

In the preferred embodiment of the present invention, the plurality of hooks 18 comprises a pair of first hooks 23 and a pair of second hooks 24, also seen in FIG. 2, FIG. 5, and FIG. 6 The pair of first hooks 23 accommodates a mixing bowl with an opening that is smaller than that of a mixing bowl with a larger opening. The main plate 2 is attached with the mixing bowl with a larger opening by the pair of second hooks 24. The pair of first hooks 23 are positioned opposite each other about the central slot 9. Similarly, the pair of second hooks 24 are positioned opposite each other about the central slot 9. This arrangement of the pair of first hooks 23 and the pair of second hooks 24 stabilizes the main plate 2 across a rim of a corresponding mixing bowl. In order to accommodate a smaller bowl, the pair of first hooks 23 are positioned adjacent the central slot 9. In order to accommodate a larger bowl, the pair of second hooks 24 are positioned in between the pair of first hooks 23 and the rim 4.

The consistency and mixture of ingredients within the mixing bowl is observed while the present invention may remain attached with a mixing bowl as the main lid 1, the supplementary lid 7, the first cover 13, and the handle 16 comprises transparent materials. Furthermore, the main lid 1, the supplementary lid 7, and the first cover 13 comprises pliable materials that both preserve the overall structure of the present invention while accommodating mixing bowl of varying sizes.

In an alternate embodiment of the present invention, a variety of ingredients are safely guided within the frame 3 and through the refill slot 11 as this alternate embodiment of the present invention comprises a funnel 25, shown in FIG. 6 and FIG. 7.

An outlet 26 of the funnel 25 is positioned opposite an inlet 27 of the funnel 25. Ingredients exit the outlet 26 of the funnel 25 in order to enter the mixing bowl. Ingredients enter the funnel 25 through the inlet 27. In order for ingredients to smoothly and continuously enter the mixing bowl through the refill slot 11 with the funnel 25, the funnel 25 tapers from the inlet 27 to the outlet 26. A first rim 28 of the funnel 25 is removably coupled with the frame 3 so that the funnel 25 is stabilized with the frame 3 and does not become dislodged while adding additional ingredients through the refill slot 11. Moreover, the outlet 26 is positioned within the first rim 28. Similarly, the inlet 27 is positioned within a second rim 29 of the funnel 25. Ingredients freely fall past the second rim 29, through the first rim 28, and into the mixing bowl as the outlet 26 is positioned adjacent the refill slot 11. This alternate embodiment further comprises a second cover 30 that allows the funnel 25 to remain attached to the mixing bowl while mixing the ingredients within the mixing bowl without ingredients splashing out the refill slot 11. The second cover 30 is positioned adjacent the second rim 29 and is hingedly connected with the second rim 29, thereby opening and covering the inlet 27 with the second cover 30. In further embodiments of the present invention, a lateral wall of the funnel 25 comprises a plurality of sections that are collapsible with each other. More specifically, the lateral wall may be housed within the frame 3 of the main lid 1 and concealed by the cover 13.

Although the invention has been explained in relation to its preferred embodiment, it is to be understood that many other possible modifications and variations can be made without departing from the spirit and scope of the invention as hereinafter claimed.

What is claimed is:

1. A mixing bowl cover comprises:
a main lid;
a supplementary lid;
a central slot;
a refill slot;
a first cover;
the main lid comprises a main plate, a frame, and a rim;
the rim being perimetrically fixed with the main plate;
the central slot and the refill slot traversing through the main plate;
the refill slot being positioned within the frame;
the frame being fixed with the main plate;
the frame being positioned opposite the rim;
the main plate being oriented perpendicular with the rim and the frame;
the frame being positioned between the central slot and an outer edge of the main plate;
a first width of the central slot being larger than a second width of the refill slot;
the supplementary lid being removably coupled with central slot;
the first cover being positioned adjacent the frame; and,
the first cover being hingedly coupled with the frame.

2. The mixing bowl cover as claimed as claim 1 comprises:
the main lid comprises a lip;
the lip being perimetrically fixed around the main plate; and,
the lip being oriented parallel with the main plate.

3. The mixing bowl cover as claimed as claim 1 comprises:
a handle;
the handle being fixed with the supplementary lid;
the handle being oriented away from the rim of the main lid; and,
a lateral surface of the supplementary lid being frictionally engaged with the central slot.

4. The mixing bowl cover as claimed as claim 1 comprises:
a knob;
the knob being fixed onto a first surface of the first cover;
the first surface of the first cover being positioned opposite a second surface of the first cover; and,
the second surface being positioned adjacent the frame.

5. The mixing bowl cover as claimed as claim 1 comprises:
a plurality of hooks;
each hook of the plurality of hooks comprises a base and a flexible arm;
the base being fixed to the main plate;
the base being positioned within the rim;
the flexible arm being positioned adjacent the base, positioned opposite the main plate;
the flexible arm traversing across the base;
a fixed end of the flexible arm being terminally fixed with the base;
the fixed end being positioned opposite a free end of the flexible arm across the flexible arm;
the fixed end being oriented towards the rim; and,
the plurality of hooks being radially distributed across the main plate.

6. The mixing bowl cover as claimed as claim 5 comprises:
the plurality of hooks comprises a pair of first hooks and a pair of second hooks;
the pair of first hooks being positioned opposite each other about the central slot;
the pair of second hooks being positioned opposite each other about the central slot;
the pair of first hooks being positioned adjacent the central slot; and,
the pair of second hooks being positioned in between the pair of first hooks and the rim.

7. The mixing bowl cover as claimed as claim 1, wherein the main lid, the supplementary lid, the first cover, and the handle comprises transparent materials.

8. The mixing bowl cover as claimed as claim 1 comprises:
a funnel;
an outlet of the funnel being positioned opposite an inlet of the funnel;
the funnel tapering from the inlet to the outlet;
a first rim of the funnel being removably coupled with the frame;
the outlet being positioned within the first rim;
the inlet being positioned within a second rim of the funnel; and,
the outlet being positioned adjacent the refill slot.

9. The mixing bowl cover as claimed as claim 1 comprises:
a second cover;
the second cover being positioned adjacent the second rim; and,
the second cover being hingedly connected with the second rim.

10. A mixing bowl cover comprises:
a main lid;
a supplementary lid;
a central slot;
a refill slot;
a first cover;
a handle;
the main lid comprises a main plate, a frame, a rim, and a lip;
the rim being perimetrically fixed with the main plate;
the central slot and the refill slot traversing through the main plate;
the refill slot being positioned within the frame;
the frame being fixed with the main plate;
the frame being positioned opposite the rim;
the main plate being oriented perpendicular with the rim and the frame;
the frame being positioned between the central slot and an outer edge of the main plate;
a first width of the central slot being larger than a second width of the refill slot;
the supplementary lid being removably coupled with central slot;
the first cover being positioned adjacent the frame;
the first cover being hingedly coupled with the frame;
the lip being perimetrically fixed around the main plate;
the lip being oriented parallel with the main plate;
the handle being fixed with the supplementary lid;
the handle being oriented away from the rim of the main lid; and,
a lateral surface of the supplementary lid being frictionally engaged with the central slot.

11. The mixing bowl cover as claimed as claim 10 comprises:
a knob;
the knob being fixed onto a first surface of the first cover;
the first surface of the first cover being positioned opposite a second surface of the first cover; and,
the second surface being positioned adjacent the frame.

12. The mixing bowl cover as claimed as claim 10 comprises:
a plurality of hooks;
each hook of the plurality of hooks comprises a base and a flexible arm;
the base being fixed to the main plate;
the base being positioned within the rim;
the flexible arm being positioned adjacent the base, positioned opposite the main plate;
the flexible arm traversing across the base;
a fixed end of the flexible arm being terminally fixed with the base;
the fixed end being positioned opposite a free end of the flexible arm across the flexible arm;
the fixed end being oriented towards the rim; and,
the plurality of hooks being radially distributed across the main plate.

13. The mixing bowl cover as claimed as claim 10 comprises:
the plurality of hooks comprises a pair of first hooks and a pair of second hooks;
the pair of first hooks being positioned opposite each other about the central slot;
the pair of second hooks being positioned opposite each other about the central slot;
the pair of first hooks being positioned adjacent the central slot; and,
the pair of second hooks being positioned in between the pair of first hooks and the rim.

14. The mixing bowl cover as claimed as claim 10, wherein the main lid, the supplementary lid, the first cover, and the handle comprises transparent materials.

15. The mixing bowl cover as claimed as claim 10 comprises:
a funnel;
an outlet of the funnel being positioned opposite an inlet of the funnel;
the funnel tapering from the inlet to the outlet;
a first rim of the funnel being removably coupled with the frame;
the outlet being positioned within the first rim;
the inlet being positioned within a second rim of the funnel; and,
the outlet being positioned adjacent the refill slot.

16. The mixing bowl cover as claimed as claim 10 comprises:
a second cover;
the second cover being positioned adjacent the second rim; and,
the second cover being hingedly connected with the second rim.
